(19) United States
(12) Patent Application Publication
(10) Pub. No.: US 2012/0085006 A1
(43) Pub. Date: Apr. 12, 2012

(54) LIGHTING FIXTURE COMPRISING INTEGRATED TILE ARRAY

(75) Inventor: Todd L. Phillips, Mount Pleasant, SC (US)

(73) Assignee: Quoizel, Inc., Goose Creek, SC (US)

(21) Appl. No.: 12/898,837

(22) Filed: Oct. 6, 2010

(51) Int. Cl. G09F 13/04; H05B 37/02

(52) U.S. Cl. 40/541; 315/152; 315/362; 315/313

(57) ABSTRACT

A lighting fixture comprising a mounting frame adapted to be mounted to a vertical mounting surface. The mounting frame supports a panel. The panel may include decorative indicia on a front surface thereof. Further, the panel may include an array of tiles thereon. The lighting fixture also comprises a mounting frame adapted to support the panel and a plurality of support arms projecting from the mounting frame. Each of the arms supports at least one lamp socket. The lighting fixture further comprises a secondary light source coupled to the mounting frame at a location between the front surface of the panel and the wall. The lighting fixture comprises control electronics adapted to selectively apply power to the light source and the at least one lamp socket. In some embodiments, the secondary light source is responsive to an activation signal from at least one of a presence detector and a photodetector.

### BACKGROUND OF THE INVENTION

The present invention relates generally to lighting fixtures. More particularly, the invention relates to an interior lighting fixture comprising decorative indicia, such as a tile array, and adapted to selectively illuminate at least two different light sources.

Many varieties of interior lighting fixtures are known. A room may have multiple fixtures, each in electrical communication with a light switch via household wiring. In particular, a pair of conductors extends between each switch and an associated electrical junction box to which the lighting fixture is mounted. The junction box is mounted to be flush with a surface, such as a wall or ceiling. The fixtures are typically mounted over the junction box and connected to the conductors to complete a circuit. Thus, a switch may be used to selectively apply power to an associated light fixture.

### SUMMARY OF THE INVENTION

In one aspect, the present invention provides a lighting fixture comprising a panel adapted to be mounted over a junction box on a wall. The panel includes decorative indicia on a front surface thereof. The lighting fixture also comprises a mounting frame adapted to support the panel and a plurality of support arms projecting from the mounting frame. Each of the arms supports at least one lamp socket. The lighting fixture further comprises a secondary light source coupled to the mounting frame at a location between the front surface of the panel and the wall. Finally, the lighting fixture comprises control electronics adapted to selectively apply power to the light source and the at least one lamp socket.

According to a further aspect, the present invention provides a lighting fixture comprising a mounting frame adapted to be mounted to an interior wall. The mounting frame supports a panel. Also, the panel is substantially parallel to and spaced apart from the interior wall. The lighting fixture further comprises a plurality of support arms projecting from the mounting frame, wherein each of the arms supports at least one lamp socket. Finally, the lighting fixture comprises a secondary light source coupled to the mounting frame and located behind the panel. The secondary light source is responsive to an activation signal from at least one of a presence detector and a photodetector.

According to a further aspect, the present invention provides a residential lighting fixture comprising a panel adapted to mounted parallel to and spaced apart from a vertical mounting surface. The panel includes an array of tiles thereon. The lighting fixture further comprises a mounting frame adapted to support the panel and a plurality of support arms cantilevered to the mounting frame. Each of the arms comprises at least one receptacle to receive a lamp. The lighting fixture also comprises a secondary light source located on the mounting frame behind the panel and switching electronics adapted to selectively apply power to the light source and the at least one lamp receptacle.

Other objects, features, and aspects of the present invention are discussed in greater detail below.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a front perspective view of a lighting fixture constructed in accordance with an embodiment of the present invention.

FIG. 2 is a side perspective view of the lighting fixture of FIG. 1.

FIG. 3 is a side perspective view of the lighting fixture of FIG. 1 wherein the panel is removed to reveal additional structure.

FIG. 4A is a diagrammatic representation of exemplary control electronics which may be incorporated into a lighting fixture in accordance with an embodiment of the present invention.

FIG. 4B is a diagram illustrating the wiring of the control electronics of FIG. 4A according to one embodiment of the present invention.

FIG. 5A is a rear perspective view of a lighting fixture in accordance with a further embodiment of the present invention.

FIG. 5B is a front perspective view of the lighting fixture of FIG. 5A.

FIG. 6A is a rear perspective view of a lighting fixture having a mounting frame which is substantially concealed behind a panel in accordance with a further embodiment of the present invention.

FIG. 6B is a front perspective view of the lighting fixture of FIG. 6A.

FIG. 7A is a front perspective view of a lighting fixture having a mounting frame comprising a panel constructed in accordance with a further embodiment of the present invention.

FIG. 7B is a schematic partial cross-sectional view of the lighting fixture of FIG. 7A.

FIG. 7C is a schematic bottom view of the lighting fixture of FIG. 7A.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Embodiments of the present invention provide a lighting fixture comprising a plurality of lamp sockets and affixed to a wall-mounted panel preferably having decorative indicia. Generally, the lighting fixture comprises a mounting frame, which may preferably be a rigid support structure adapted to support multiple light sources. At least one support arm projects from the mounting frame and has at least one socket or receptacle to receive a lamp.

The lighting fixture may also be equipped with a secondary light source for low-level lighting in the dark. Preferably, the secondary light source is coupled to the mounting frame and mounted between a front surface of the panel and the wall. In some embodiments, the secondary light source may comprise a plurality of light-emitting diodes (LEDs) or the like. Notably, the lighting fixture further comprises control electronics which facilitate the selective application of power to either or both of the lamp sockets and the secondary light source.

As described in more detail below, the lighting fixture of the present invention permits a variety of configurations for supporting the panel. According to some embodiments, the panel may be adapted to be mounted substantially parallel to but spaced apart from an interior wall. For example, this enables a secondary light source mounted behind the panel to radiate light around the panel to create an aesthetically-pleasing corona or halo.

In these “floating panel” embodiments, the mounting frame may comprise at least one panel support member to facilitate attachment of the panel to the mounting frame. The panel may be coupled to the at least one panel support member at various locations by one or more brackets attached to the back side of the panel. Also, the mounting frame may comprise a backplate coupled to the at least one panel support member to facilitate attachment of the lighting fixture to the wall and spacing of the panel relative to the wall.

Alternatively, in some embodiments described below, the mounting frame may comprise the panel. This configuration may permit the panel to be flush-mounted to a wall. Additionally, in further embodiments, a selectively-illuminable secondary light source may be provided along at least one peripheral surface of the panel to illuminate a wall.

The decorative indicia on the panel may preferably comprise an array of tiles. As used herein, the term tiles broadly encompasses the many types of tiles known to those of skill in the art. For example, tiles may be relatively small, thin structures of any shape, and they may be formed of a multitude of different materials, such as ceramics (including glass and clay), wood, stone, concrete, or plastic, as needed or desired.

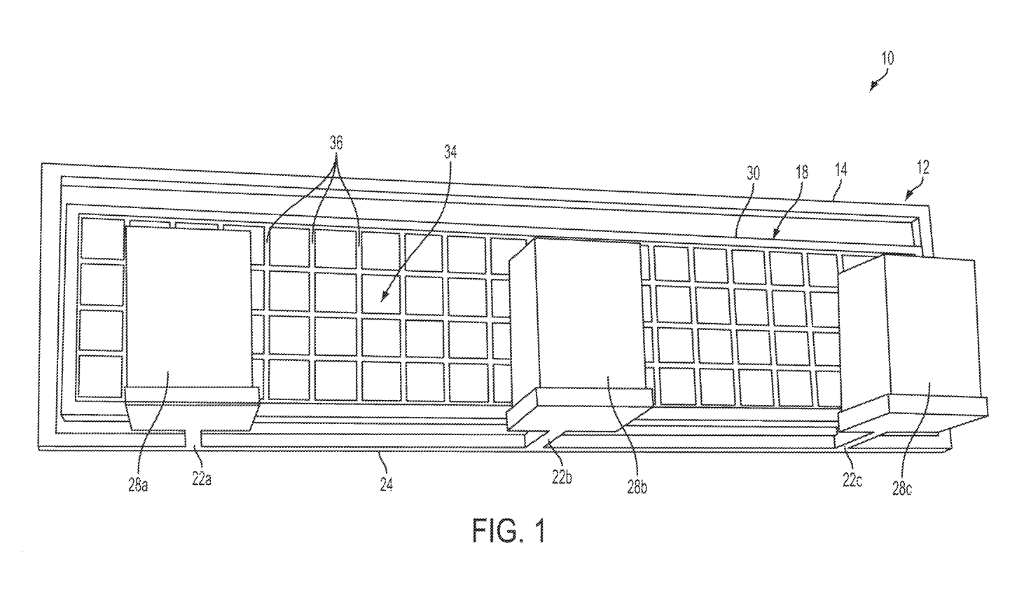

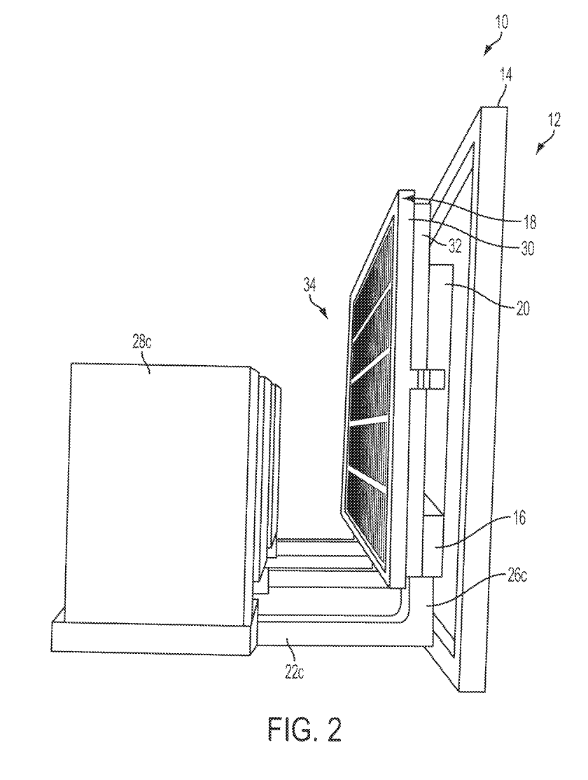

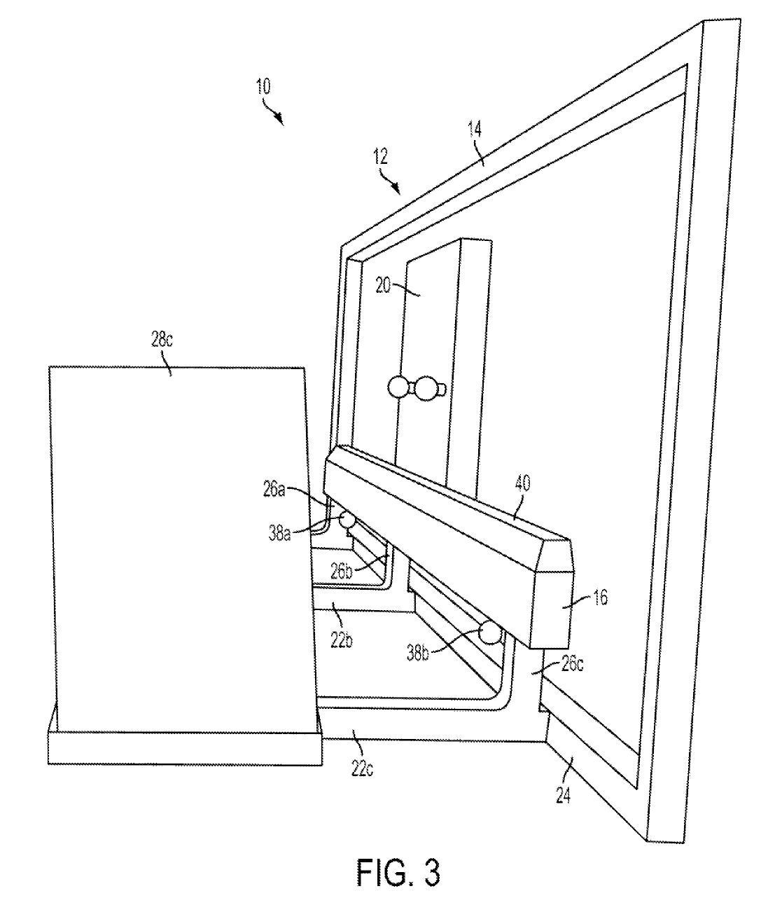

In this regard, FIGS. 1-3 illustrate a lighting fixture 10 according to one embodiment of the present invention adapted to be mounted to an interior surface, such as over a junction box in a wall. As can be seen, lighting fixture 10 comprises a mounting frame 12. Those of skill in the art will appreciate that the mounting frame may take many different shapes within the scope of the present invention. In this embodiment, for example, mounting frame 12 comprises a brace 14, which may be a substantially rectangular support structure coupled to a panel support member. Here, the panel support member may be formed as a joist 16 (see FIGS. 2-3). Mounting frame 12 is preferably formed of a material suitable for supporting a light fixture mounted on a wall. For example, mounting frame 12 may be formed of metal, such as brass or aluminum.

Joist 16 may preferably be an elongate, beam-like structure of rectangular cross-section which extends parallel to an interior wall. As described below, joist 16 may be used to support a panel 18 comprising decorative indicia.

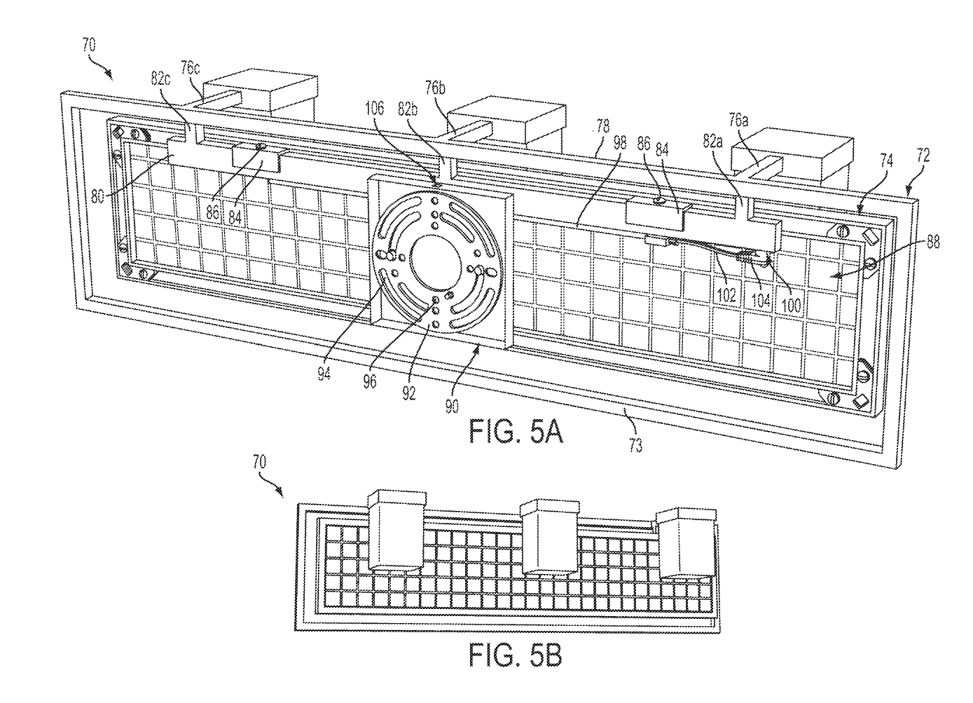

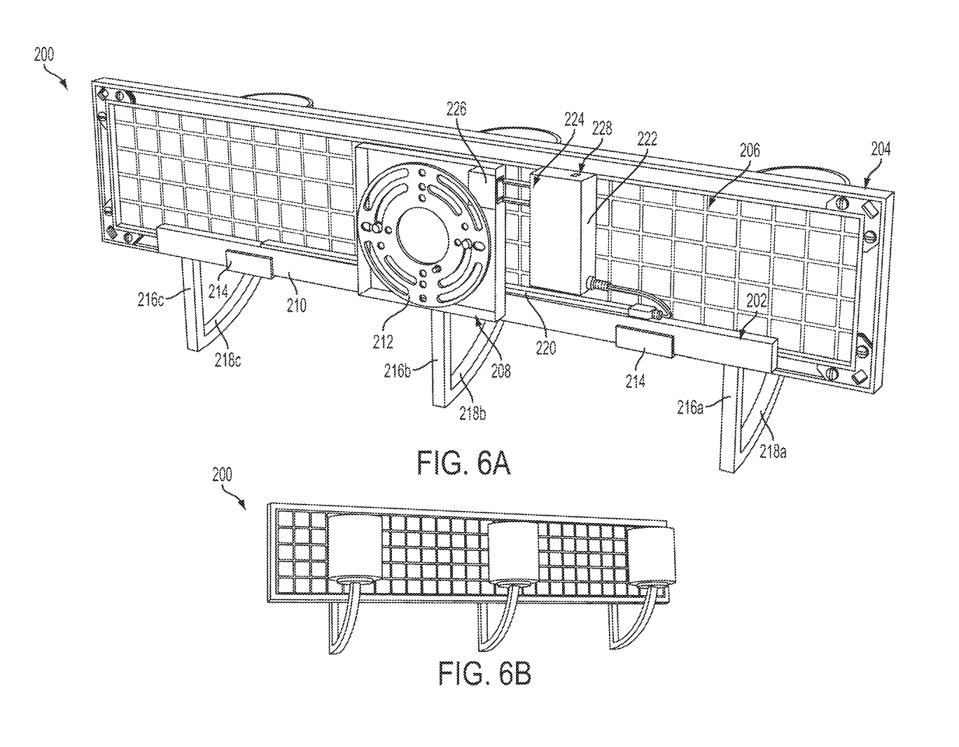

Mounting frame 12 may additionally comprise a backplate 20 that may preferably be sized to cover a mounting bracket (see, e.g., FIGS. 5A-6B) fastened to a junction box in the wall. Generally, backplate 20 may comprise a shallow, box-like structure formed of the same material as frame 12 that, when connected to a mounting bracket, lies flush against the wall. As described in more detail below, backplate 20 may also preferably house the control electronics of lighting fixture 10.

In this embodiment, three support arms 22a, 22b, and 22c are cantilevered to a bottom segment 24 of brace 14. It will be appreciated, however, that the support arms may project from any suitable location on the mounting frame. Preferably, the mounting frame and the support arms are formed of the same material. Here, joist 16 is coupled to support arms 22a-c via posts 26a-c, respectively. Further, to facilitate mounting, backplate 20 is preferably rigidly affixed to joist 16, for example by welding or suitable mounting hardware.

Each support arm preferably supports at least one socket or receptacle to receive a lamp. The type of socket or receptacle provided will be based on the type of lamp needed or desired, and those of skill in the art can select a socket suitable to receive the base of a desired lamp. In some embodiments, the sockets may be adapted to receive a halogen lamp, such as a G9 halogen bulb. Often, the support arms of the lighting fixture of the present invention are further adapted to receive a lamp shade. For example, each support arm 22a-c is adapted to receive a box-shaped shade 28a, 28b, 28c, respectively, formed of frosted glass in this embodiment. Lamps received in each socket on support arms 22a-c may be surrounded by shades 28a-c, respectively.

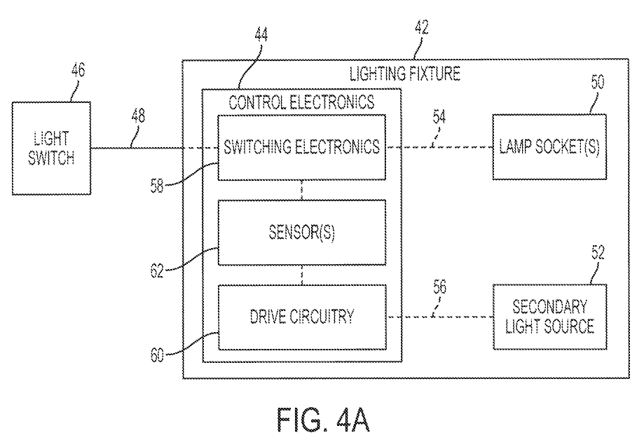

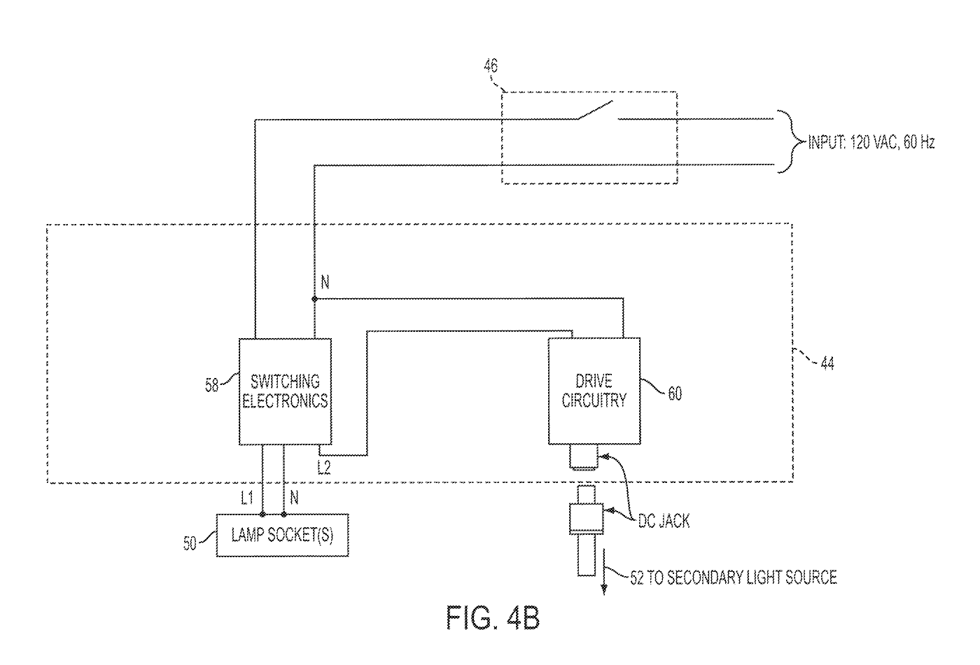

As described below in reference to FIG. 4, the lighting fixture of the present invention comprises suitable control electronics in electrical communication with a power supply to supply power to each socket. When lighting fixture 10 is illuminated, decorative indicia on panel 18 may reflect light radiating from the lamps associated with each support arm 22a-c to create a pleasant light effect.

Panel 18 may preferably comprise a rectangular frame 30 surrounding and supporting a substrate 32 to which the decorative indicia may be affixed. However, those of skill in the art will appreciate that the panel need not be rectangular and may define any suitable shape for supporting decorative indicia, as needed or desired. Substrate 32 may comprise a thin, flat panel of material suitable for mounting decorative indicia, including metal, glass, or plastic. For example, substrate 32 may preferably be a light-transmissive panel of textured glass.

As shown, the decorative indicia of panel 18 comprise an array of tiles 34. In preferred embodiments, the tiles in tile array 34 may be formed of a light-transmissive material, such as glass or the like, and may be affixed to substrate 32. The tiles may be disposed on substrate 32 in spaced relation to one another to define a grid of intersecting grout-joints 36. To facilitate alignment on substrate 32, in one embodiment the tiles may be pre-arranged on an adhesive film. In particular, the top surfaces of the tiles may be removably attached to the film and the bottom surfaces of the tiles may be glued to substrate 32. After the adhesive sets, the film may be removed from the top surfaces of the tiles. Those of skill in the art are familiar with suitable adhesives for affixing tiles to substrate 32, such as mortar, epoxy, or a silicone adhesive. Grout-joints 36 between individual tiles in tile array 34 may be sealed with grout or silicone, which in some embodiments may also be light-transmissive. Sealing is not required, however, and in alternative embodiments the tiles may be affixed to the panel without sealing the grout-joints to enhance the transmission of light therethrough.

As noted above, panel 18 is suitably connected to mounting frame 12. In this embodiment, for example, suitable fasteners may be used to attach panel 18 to joist 16. In particular, a first pair of holes, which may preferably be threaded, may be defined on the underside of joist 16. In addition, one or more brackets (see, e.g., FIGS. 5A-6B) may be coupled to panel 18. The bracket(s) preferably define a second pair of holes aligned with the first pair of holes in joist 16. Then, threaded fasteners 38a and 38b, which here comprise a decorative, spherical head, may be inserted into the first and second pairs of holes to removably attach panel 18 to joist 16.

Further, in many embodiments a secondary light source is preferably coupled to the mounting frame. The secondary light source may be in electrical communication with the power supply via the lighting fixture's control electronics described below. Typically, the secondary light source may be located behind the panel, such that when it is illuminated it creates a corona or halo around the panel. For example, where the mounting frame comprises a panel support member (e.g., joist 16), the secondary light source may preferably be positioned along a top or bottom surface thereof. Notably, however, the secondary light source may be arranged at any location between the front surface of the panel and the wall to which the fixture is mounted. For example, the secondary light source may be provided along a bottom surface of the panel such that it may illuminate the wall below the panel.

In some preferred embodiments, the secondary light source may be an array of LEDs, such as an LED strip. As is known, an LED strip generally comprises a plurality of LEDs in electrical communication along the length of a flexible carrier. The LED strip may be enclosed in a transparent protective sheathing. Further, the LEDs may typically be arranged in series and connected to drive circuitry. A suitable LED strip is selected based on various factors, including the desired size of the strip and mounting location on the frame, power requirements, and aesthetics, among others. Other light sources are contemplated, including various types of incandescent and gas-discharge light sources.

For example, in the embodiment shown in FIG. 3, the secondary light source comprises an LED strip 40 affixed along a top face of joist 16. LED strip 40 may be affixed to joist 16 using a suitable adhesive or appropriate mounting hardware. As described below, LED strip 40 may be in electrical communication with lighting fixture 10's control electronics, which preferably comprises suitable drive circuitry for LED strip 40.

FIG. 4A is a diagrammatic representation of exemplary control electronics which may be incorporated into a lighting fixture in accordance with an embodiment of the present invention. As explained above, in typical residential installations, a pair of conductors extending from a light switch on a wall may terminate at a junction box where the lighting fixture is mounted. In embodiments of the lighting fixture of the present invention, the control electronics preferably enable use of a single light switch to selectively apply power to both the socket(s) on the at least one support arm and the secondary light source. In this regard, a lighting fixture 42, which may preferably be analogous to lighting fixture 10, may comprise control electronics 44. When lighting fixture 42 is mounted on a wall, its control electronics 44 may be in electrical communication with a light switch 46 via conductors 48. Thus, when a user switches light switch 46 to the “on” position, the circuit is closed and power may be applied to control electronics 44.

As with lighting fixture 10, lighting fixture 42 comprises at least one lamp socket 50 and a secondary light source 52. In preferred embodiments, secondary light source 52 may be an LED strip. Control electronics 44 may be in electrical communication with the socket(s) 50 and the secondary light source 52 via suitable conductors 54, 56, respectively. In some embodiments, conductors 54, 56 may extend at least partially within lighting fixture 42's mounting frame. Also, in further embodiments a pull-cord may be provided to turn on and off lamps received in lamp socket(s) 50.

Control electronics 44 may preferably comprise switching electronics 58 and drive circuitry 60. Switching electronics 58 are preferably adapted to alternately route AC power applied to control electronics 44 via conductors 48 to either or both of lamp socket(s) 50 or secondary light source 52 each time light switch 46 is switched to the “on” position. Thus, switching electronics 58 may comprise control logic and/or a suitable changeover switch or single pole double throw switch known to those of skill in the art.

Drive circuitry 60, which may preferably be electrically interposed between switching electronics 58 and secondary light source 52, may be adapted to control secondary light source 52. Those of skill in the art may readily select suitable drive circuitry depending on the secondary light source provided. For example, where the secondary light source is an array of LEDs, the drive circuitry may comprise an appropriate LED driver circuit adapted to regulate the drive parameters (e.g., voltage, bias current, and duty cycle) of an LED array. The drive circuitry may also comprise an AC to DC power converter. Where the secondary light source is fluorescent, the drive circuitry may comprise a ballast.

Components of control electronics 44 may be housed in any suitable location in lighting fixture 42. For example, some components of control electronics 44 may preferably be provided on a printed circuit board or the like housed in or on lighting fixture 42's backplate (if a backplate is provided). Alternatively, components may also be provided within the panel of lighting fixture 42 or on a back surface thereof. For example, components may be affixed to lighting fixture 42 using double-sided tape. In some embodiments, the drive circuitry 60 may be a part of a separate, detachable component that may plug into an outlet on the lighting fixture's mounting frame or backplate.

Further, in some embodiments the control electronics may comprise one or more sensors which automatically turn on or off the secondary light source based upon predetermined conditions, such as a low level of ambient light or detection of motion. For example, control electronics 44 may comprise one or more sensors 62 coupled to lighting fixture 42. As shown, sensor(s) 62 may be electrically interposed at least between switching electronics 58 and secondary light source 52. Sensor(s) 62 may then prevent illumination of secondary light source 52 until a predetermined condition (such as the detection of a low level of ambient light) is satisfied. In alternative embodiments described below, it may be desirable to also electrically interpose other sensors between switching electronics 58 and lamp socket(s) 50.

In some embodiments, sensor(s) 62 may comprise either or both of a photodetector (i.e., a light sensor) and a presence sensor, both of which are known to those of skill in the art. For example, suitable photodetectors may include any known semiconductor-based light sensor, such as a photoresistor, photodiode, or phototransistor. Where sensor(s) 62 comprise a photodetector, the sensor may be mounted on lighting fixture 42 in any location which permits ready exposure to ambient light. Also, suitable presence sensors may include passive infrared or acoustic motion detectors.

In operation, when the light switch is in the “off” position, the circuit is broken and power is not applied to either socket(s) 50 or the secondary light source 52. However, each time power is applied to control electronics 44, switching electronics 58 preferably alternately directs power to 1) lamp socket(s) 50; 2) secondary light source 52; and, optionally, 3) both lamp socket(s) 50 and secondary light source 52.

Thus, when a user places light switch 46 in the “on” position a first time, switching electronics may route power to lamp socket(s) 50 alone. When it is desired to operate secondary light source 52, a user may place light switch 46 in the “off” position and then place light switch 46 back into the “on” position a second time. In this case, switching electronics 58 may direct power to sensor(s) 62 and/or drive circuitry 60. (In some embodiments, switching electronics 58 may only do so when the user switches light switch 46 to the “on” position a second time within a predetermined amount of time after placing light switch 46 in the “off” position. For example, the predetermined amount of time may be one second.) In any case, sensor(s) 62 may then prevent illumination of secondary light source 52 until a predetermined condition is satisfied. (Where sensor(s) 62 are not provided, placing light switch 46 in the “on” position a second time may simply cause power to be applied to drive circuitry 60 and illuminate secondary light source 52.)

For example, where sensor(s) 62 comprise a photodetector, secondary light source 52 may be illuminated only when a low level of ambient light is detected. Alternatively, where sensor(s) 62 comprise a presence detector, secondary light source 52 may be illuminated only when a person enters the room. Notably, either arrangement allows the secondary light source to function as a “built-in” nightlight.

Finally, in some embodiments it may be desirable to operate both the lamp(s) received in lamp socket(s) 50 and secondary light source 52 simultaneously. In these cases, a user may place light switch 46 in the “off” position and then place light switch 46 back into the “on” position a third time. Then, switching electronics 58 may direct power to both lamp socket(s) 50 and secondary light source 52.

This third setting permits further sensor arrangements. For example, sensor(s) 62 may comprise a photodetector, and a presence sensor may be electrically interposed between switching electronics 58 and lamp socket(s) 50. Then, after a person has left the room at night, only secondary light source 52 may remain illuminated. When a person reenters the room, the presence detector will cause the lamps in lamp socket(s) 50 to be illuminated.

FIG. 4B is a diagram illustrating the wiring of control electronics 44 according to one embodiment of the present invention. For ease of illustration, sensor(s) 62 are not provided in this embodiment. In particular, light switch 46 allows 120 V AC power at 60 Hz to be applied to switching electronics 58. As noted above, when a user desires to apply power to lamp socket(s) 50, switch 46 may be closed and switching electronics 58 direct power to conductor L1. As shown, a conductor N completes the circuit. Similarly, when a user desires to apply power to secondary light source 52, switch 46 may be closed a second time. In this case, switching electronics 58 direct power to conductor L2. Secondary light source 52 may be connected to the output of drive circuitry 60 via a DC jack in some embodiments.

FIGS. 5A-5B are respective rear and front perspective views of a lighting fixture 70 in accordance with a further embodiment of the present invention. Lighting fixture 70 is in many respects similar to lighting fixture 10 and comprises a mounting frame 72 (which comprises a substantially rectangular brace 73) and a panel 74. However, in this embodiment support arms 76a-c project from a top segment 78 of brace 73. Support arms 76a-c are preferably otherwise analogous to support arms 22a-c and thus may be adapted to support at least one lamp socket. Additionally, the panel 74 support member in this embodiment is a joist 80 which depends from support arms 76a-c via posts 82a-c.

As with panel 18, panel 74 comprises brackets 84 which are coupled to joist 80 via fasteners 86. Thereby, panel 74 may be spaced apart from the wall to which the lighting fixture 70 is attached. Additionally, panel 74 may comprise a light-transmissive substrate 88 to which decorative indicia may be affixed.

Mounting frame 72 of lighting fixture 70 also comprises a backplate 90 that may be rigidly coupled to joist 80. Backplate 90 is preferably analogous to backplate 20 described above. Thus, backplate 90 may be adapted to attach to and cover a mounting bracket 92. As shown, mounting bracket 92 defines a plurality of radial slots 94 and/or holes 96 so that bracket 92 may be attached to junction boxes of various sizes. Those of skill in the art will appreciate, however, that the lighting fixture of the present invention is suitable for use with many types of mounting brackets.

During assembly, a user may typically first fasten mounting bracket 92 to a junction box in a wall. Thereafter, the user may mount lighting fixture 70 on the wall by attaching backplate 90 to mounting bracket 92 using suitable mounting hardware. Panel 74 may be removed from lighting fixture 70 during mounting to facilitate attachment to bracket 92.

In the embodiment illustrated in FIG. 5A, control electronics are housed in backplate 90 and adapted to be coupled to a power supply. Lighting fixture 70's control electronics are preferably analogous to control electronics 44, described above. In addition, lighting fixture 70 may comprise suitable conductors extending within mounting frame 72 between the control electronics and the various light sources of lighting fixture 70.

The secondary light source in this embodiment comprises an LED strip 98. LED strip 98 may preferably be analogous to LED strip 40, but here LED strip 98 is attached to mounting frame 72 along the bottom face of joist 80. Joist 80 preferably comprises a built-in socket 100 on an end thereof to allow power to be supplied to the LED strip 98. In this embodiment, the drive circuitry of the control electronics is built into the backplate 90 and in electrical communication with socket 100. Thus, LED strip 98 may be in electrical communication with the control electronics via a cord 102 terminating in a plug 104.

Additionally, lighting fixture 70 preferably comprises a photodetector 106 mounted to a top surface of backplate 90. However, those of skill in the art will appreciate that photodetector 106 may be mounted at any location on lighting fixture 70 that provides ready exposure of photodetector 106 to ambient light. Photodetector 106 may preferably be analogous to the photodetector of sensor(s) 62 described above.

In certain installations it may be desirable to provide a mounting frame defining a less conspicuous support structure when the lighting fixture is mounted to a wall. In this regard, FIGS. 6A-6B are respective rear and front perspective views of a lighting fixture 200 having a mounting frame which is substantially concealed behind a panel in accordance with a further embodiment of the present invention. In particular, lighting fixture 200 comprises a mounting frame 202 to which a panel 204 is removably attached. Panel 204 comprises decorative indicia affixed to a light-transmissive substrate 206. In many respects, lighting fixture 200 may be analogous to lighting fixtures 10 and 70 described above. However, the mounting frame in this embodiment defines a smaller support structure than that of lighting fixture 10.

Specifically, mounting frame 202 comprises a backplate 208 affixed to a joist 210. Notably, in this embodiment, mounting frame 202 does not comprise a support structure analogous to braces 14, 73 described above. Nonetheless, backplate 208 of mounting frame 202 is substantially analogous to backplate 90 and thus may be adapted to attach to and cover a mounting bracket 212. Further, as with panels 20 and 74, panel 204 may comprise brackets 214 which are coupled to joist 210. Thus, although a brace is not provided in this embodiment, mounting frame 202 still permits panel 204 to be mounted spaced apart from a wall.

In this embodiment, three posts 216a-c extend downwardly from joist 210, and arcuate support arms 218a-c project from the distal ends of respective posts 216a-c in planes perpendicular to a front surface of panel 204. Support arms 218a-c are in other respects preferably analogous to support arms 22a-c and 76a-c. Thus, arms 218a-c may each preferably support at least one lamp socket.

Lighting fixture 200 comprises control electronics preferably analogous to control electronics 44. Thus, the control electronics may comprise switching electronics, at least one sensor as describe above, and suitable drive circuitry for a secondary light source. As shown, the secondary light source of light fixture 200 comprises an LED strip 220. Also, as described below, in this embodiment backplate 208 may house only the switching electronics to facilitate the selective application of power to the at least one socket of support arms 218a-c and the secondary light source.

LED strip 220 is preferably analogous to LED strip 98 of lighting fixture 70, but in this embodiment LED strip 220 is affixed to the top surface of joist 210. However, in this embodiment the drive circuitry of the control electronics may be selectively detachable. Specifically, LED strip 220 may be in electrical communication with drive circuitry housed in a drive circuitry housing 222. Drive circuitry housing 222 preferably comprises a plug 224 that may be received in a socket 226 built into backplate 208. Socket 226 is preferably in electrical communication with lighting fixture 200's control electronics. Thus, in this embodiment, a user may operate lighting fixture 200 with or without a secondary light source (or “built-in” nightlight) as needed or desired.

Additionally, lighting fixture 200 preferably comprises a photodetector 228 which is in this case mounted to a top surface of drive circuitry housing 222. Photodetector 228 may preferably be analogous to the photodetector of sensor(s) 62 described above. Photodetector 228 is preferably in electrical communication with the drive circuitry in housing 222 and the switching electronics in backplate 208 when plug 224 is inserted in socket 226. Thus, photodetector 228 may only be operated in conjunction with the drive circuitry in this embodiment.

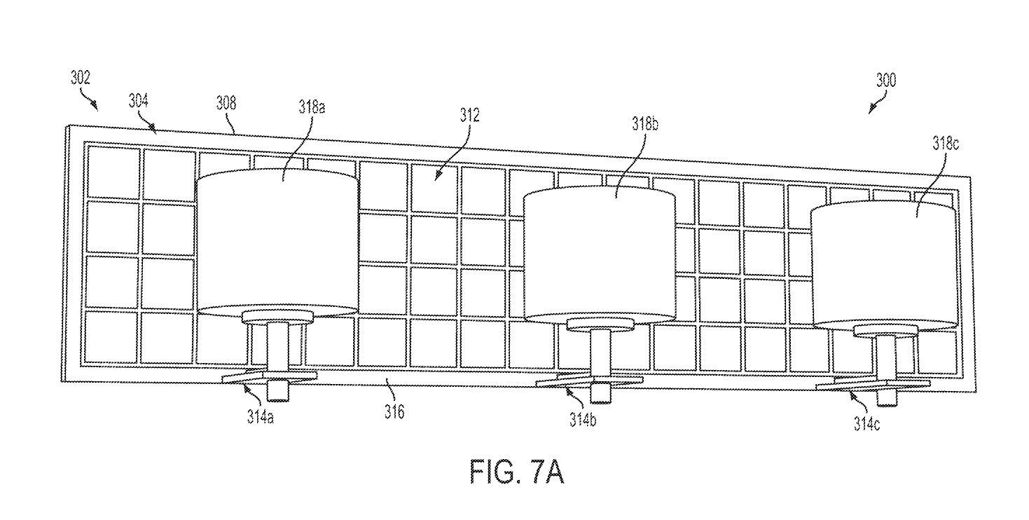

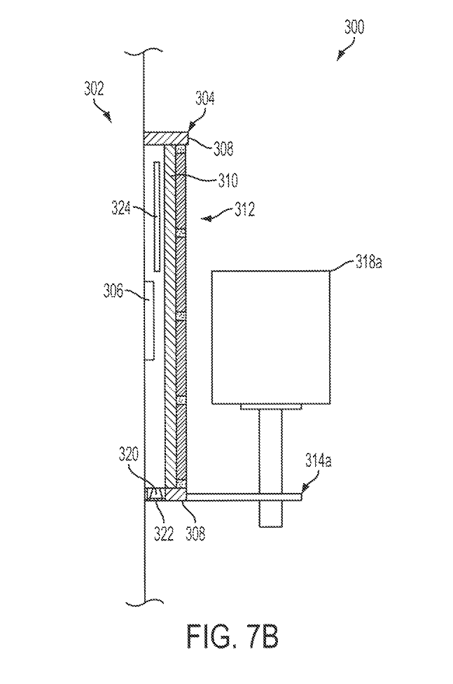

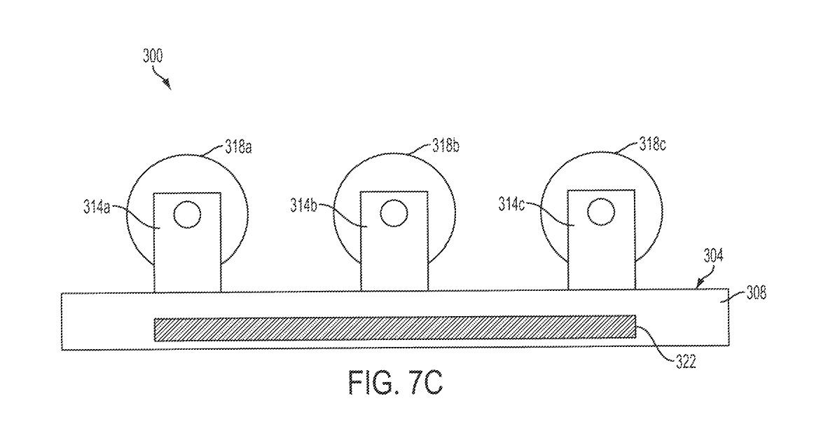

Notably, other mounting frame configurations are contemplated. For example, some embodiments of the lighting fixture of the present invention may have a mounting frame comprising a panel. This may allow a user to mount the panel substantially flush with an interior wall. For example, FIGS. 7A through 7C illustrate a lighting fixture 300 having a mounting frame comprising a panel constructed in accordance with a further embodiment of the present invention. As shown, lighting fixture 300 comprises a mounting frame 302. In one embodiment, mounting frame 302 may comprise a panel 304 and a mounting bracket 306 directly coupled to panel 304. Mounting bracket 306 is preferably adapted to be coupled to a junction box in an interior wall. Thereby, panel 304 may be mounted substantially flush against the wall. Those of skill in the art will appreciate, however, that in other embodiments, the mounting bracket may be sized to space the panel apart from the interior wall.

In preferred embodiments, panel 304 may comprise a substantially rectangular frame 308 surrounding and supporting a substrate 310. Also, decorative indicia, such as tile array 312, may preferably be affixed to substrate 310. Further, because mounting frame 302 comprises panel 304, support arms 314a-c project from a bottom member 316 of frame 308 in this embodiment. Support arms 314a-c preferably each support at least one lamp socket. In the illustrated embodiment, cylindrical, frosted-glass shades 318a-c surround lamps received in each lamp socket.

Lighting fixture 300 preferably comprises a secondary light source located within the panel and adapted to illuminate the wall to which lighting fixture 300 is mounted. For example, in this embodiment light fixture 300 comprises an LED strip 320 located within panel 304. In particular, LED strip 320, which may preferably be analogous to LED strips 98 and 220, may be mounted within bottom member 316 of frame 308. However, those of skill in the art will appreciate that the secondary light source may be provided in any suitable location in the panel where the secondary light source may illuminate the interior wall, such as along top or side members of the panel's frame. Additionally, more than one secondary light source may be provided in this embodiment.

As shown in FIG. 7B, LED strip 320 may be adapted to emit light downward from lighting fixture 300 to illuminate the wall. Referring also to FIG. 7C, light emitted from LED strip 320 may pass first through a lens 322 mounted flush along a bottom surface of bottom member 316. In some embodiments, lens 322 may be adapted to diffuse the light emitted by LED strip 320.

Further, lighting fixture 300 preferably comprises control electronics adapted for electronic communication with a power supply, lamp sockets supported by each support arm 314a-c, and LED strip 320. The control electronics may preferably be analogous to control electronics 44. Also, in this embodiment, some or all of the components of the control electronics may preferably be located on a printed circuit board 324 housed within panel 304. For example, switching electronics may be provided on printed circuit board 324 and may be in electrical communication with a photosensor provided on panel 304.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

1. A lighting fixture comprising:
a panel adapted to be mounted over a junction box on a wall, said panel including decorative indicia on a front surface thereof;
a mounting frame adapted to support said panel;
a plurality of support arms projecting from said mounting frame, each of said arms supporting at least one lamp socket;
a secondary light source coupled to said mounting frame at a location between said front surface of said panel and said wall; and
control electronics adapted to selectively apply power to said light source and said at least one lamp socket.

2. A lighting fixture as in claim 1, wherein said mounting frame comprises said panel.

3. A lighting fixture as in claim 1, wherein said panel and said mounting frame are separate.

4. A lighting fixture as in claim 3, wherein said mounting frame comprises a panel support member.

5. A lighting fixture as in claim 4, wherein said panel support member is a joist.

6. A lighting fixture as in claim 4, wherein said panel is removably attached to said panel support member.

7. A lighting fixture as in claim 6, wherein said panel is coupled to said panel support member via brackets.

8. A lighting fixture as in claim 3, wherein said mounting frame comprises a backplate.

9. A lighting fixture as in claim 1, wherein said panel is mounted spaced apart from said wall.

10. A lighting fixture as in claim 1, wherein said decorative indicia comprises an array of tiles.

11. A lighting fixture as in claim 10, wherein tiles in said array of tiles are light-transmissive.

12. A lighting fixture as in claim 1, wherein said secondary light source comprises a plurality of light-emitting diodes.

13. A lighting fixture as in claim 1, wherein said secondary light source comprises a gas-discharge lamp.

14. A lighting fixture as in claim 1, wherein said secondary light source comprises an incandescent lamp.

15. A lighting fixture as in claim 1, wherein said control electronics comprise a presence detector.

16. A lighting fixture as in claim 1, wherein said control electronics comprise a photodetector.

17. A lighting fixture comprising:
a mounting frame adapted to be mounted to an interior wall, said mounting frame supporting a panel;
wherein said panel is substantially parallel to and spaced apart from said interior wall;
a plurality of support arms projecting from said mounting frame, each of said arms supporting at least one lamp socket; and
a secondary light source coupled to said mounting frame and located behind said panel;
wherein said secondary light source is responsive to an activation signal from at least one of a presence detector and a photodetector.

18. A lighting fixture as in claim 17, wherein said lighting fixture further comprises control electronics.

19. A lighting fixture as in claim 18, wherein said secondary light source comprises a plurality of light-emitting diodes.

20. A lighting fixture as in claim 19, wherein said panel includes decorative indicia on a front surface thereof.

21. A lighting fixture as in claim 20, wherein said decorative indicia comprises an array of tiles.

22. A lighting fixture as in claim 21, wherein tiles in said array of tiles are light-transmissive.

23. A lighting fixture as in claim 17, wherein said mounting frame comprises a panel support member.

24. A lighting fixture as in claim 23, wherein said panel is removably attached to said panel support member.

25. A lighting fixture as in claim 24, wherein said panel is coupled to said panel support member via brackets.

26. A lighting fixture as in claim 23, wherein said mounting frame comprises a backplate.

27. A lighting fixture as in claim 23, wherein said panel support member is a joist.

28. A lighting fixture as in claim 17, wherein said mounting frame is formed of either brass or aluminum.

29. A lighting fixture as in claim 17, wherein said mounting frame comprises a brace.

30. A residential lighting fixture comprising:
a panel adapted to mounted parallel to and spaced apart from a vertical mounting surface, said panel including an array of tiles thereon;
a mounting frame adapted to support said panel;
a plurality of support arms cantilevered to said mounting frame, each of said arms comprising at least one receptacle to receive a lamp;
a secondary light source located on said mounting frame behind said panel; and
switching electronics adapted to selectively apply power to said light source and said at least one lamp receptacle.

31. A lighting fixture as in claim 30, wherein said secondary light source comprises a plurality of light-emitting diodes.

32. A lighting fixture as in claim 31, wherein said lighting fixture further comprises drive circuitry to control said plurality of light-emitting diodes.

33. A lighting fixture as in claim 30, wherein said panel mounting frame comprises a panel support member.

34. A lighting fixture as in claim 31, wherein said panel is removably attached to said panel support member.

35. A lighting fixture as in claim 34, wherein said panel is coupled to said panel support member via brackets.

36. A lighting fixture as in claim 30, wherein said switching electronics are in electrical communication with at least one of a presence sensor and a photodetector.

37. A lighting fixture as in claim 30, wherein said mounting frame comprises a backplate.

38. A lighting fixture as in claim 30, wherein said mounting frame comprises a brace.

39. A lighting fixture comprising:
a panel adapted to be mounted over a junction box on a wall, said panel including an array of tiles thereon;
a mounting frame adapted to support said panel; and
a plurality of support arms projecting from said mounting frame, each of said arms supporting at least one lamp socket.

40. A lighting fixture comprising:
a mounting frame adapted to be mounted to an interior wall, said mounting frame supporting a panel;
wherein said panel is substantially parallel to and spaced apart from said interior wall;
a plurality of support arms projecting from said mounting frame, each of said arms supporting at least one lamp socket; and
a secondary light source coupled to said mounting frame at a location between said front surface of said panel and said wall.
